(19) United States
(12) Patent Application Publication
(10) Pub. No.: US 2026/0342011 A1
(43) Pub. Date: Oct. 29, 2026

(54) ELECTRICAL CONNECTOR WITH PULL-UNLOCKING STRUCTURE

(71) Applicant: ZHEJIANG ZHAOLONG INTERCONNECT TECHNOLOGY CO., LTD., ZHEJIANG (CN)

(72) Inventors: Shi-Jung CHEN, ZHEJIANG (CN); Chun-Hua CHEN, ZHEJIANG (CN); Li-Feng WANG, ZHEJIANG (CN)

(21) Appl. No.: 19/187,142

(22) Filed: Apr. 23, 2025

(51) Int. Cl. H01R 13/633

(52) U.S. Cl. CPC H01R 13/6335

(57) ABSTRACT

An electrical connector includes an insulation seat, a conduction part, a locking piece and a pull strap. The insulation seat includes a main body and a tongue plate connected to the body. The main body includes a top wall, and a receiving slot is defined on the top wall. The conduction part includes multiple conductive pads arranged on the tongue plate and multiple wires connected to the conductive pads. The locking piece includes two U-shaped spring plates and an insertion plate straddles the two U-shaped spring plates. The U-shaped spring plates are positioned in the receiving slot, and a through slot is defined on the insertion plate. The pull strap includes two fixing sections and a holding section connected to the fixing sections. The fixing sections wrap around the through slot and is engaged with the locking piece to make the holding section protrude out of the insulation seat.

### BACKGROUND OF THE DISCLOSURE

### Technical Field

The technical field relates to a connector, and particularly to an electrical connector with a pull-unlocking structure.

### DESCRIPTION OF RELATED ART

Electrical connectors are important components for transmitting electrical signals or power between electronic devices. Their structural design and functions are crucial to the performance and reliability of electronic devices. Additionally, electrical connectors have widely adopted the position-locking function to ensure the stability of the connection and avoid accidental disconnection.

Furthermore, the electrical connector of the related art has adopted a pull-unlocking structure. This type of electrical connector has a flexible tab on the outside of the connector body. The user pulls the tab to activate the unlocking mechanism, and the connector transitions from a locked state to an unlocked state. However, the electrical connector of the related art often encounters issues during use, such as unlocking failures or damage to the tab due to uneven force application. This is often caused by improper direction or angle of force when pulling the tab, and thus it needs to be improved.

In view of the above drawbacks, the inventor proposes this disclosure based on his expert knowledge and elaborate researches in order to solve the problems of related art.

### SUMMARY OF THE DISCLOSURE

This disclosure provides an electrical connector with a pull-unlocking structure for applying force in a balanced manner and improving the convenience of operation.

This disclosure is an electrical connector including an insulation seat, a conduction part, a locking piece, and a pull strap. The insulation seat includes a main body and a tongue plate connected to the main body. The main body includes a top wall, and a receiving slot is defined on the top wall. The conduction part includes a plurality of conductive pads arranged on the tongue plate and a plurality of wires connected to the conductive pads. The locking piece includes two U-shaped spring plates spaced apart and an insertion plate connected to the two U-shaped spring plates. The two U-shaped spring plates are positioned in the receiving slot. The insertion plate extends between the two U-shaped spring plates, and a through slot is defined on the insertion plate. The pull strap includes two fixing sections spaced apart and a holding section connected to the two fixing sections. The two fixing sections wrap around the through slot to be engaged with the locking piece to make the holding section protrude out of the insulation seat.

In one embodiment of this disclosure, the main body includes a plurality of locking blocks located in the receiving slot, and a plurality of locking slots are defined on bottoms of the two U-shaped spring plates, and the locking blocks are engaged in the locking slots.

In one embodiment of this disclosure, the main body includes a limiting block located on two sides of the receiving slot, and top walls of the two U-shaped springs are pressed against the limiting block.

In one embodiment of this disclosure, the electrical connector further includes a pressing shaft. The main body includes a plurality of hooks and a plurality of blocking blocks located on a side of the receiving slot, and the pressing shaft passes through the hooks and is blocked by the blocking blocks to press against the two fixing sections.

In one embodiment of this disclosure, the blocking blocks includes two outer blocks located on outsides of the two fixing sections and one middle block located between the two fixing sections.

In one embodiment of this disclosure, the mating connector comprises a plurality of latch grooves, and the locking piece comprises a plurality of latch portions located on top walls of the two U-shaped springs, and the electrical connector is positioned relative to the mating connector through the latch portions engaging with the latch grooves.

In one embodiment of this disclosure, the pull strap comprises an upper pull tab, a lower pull tab, and a folding piece connected to the upper pull tab and lower pull tab; a closed end is configured on the pull strap to wrap around the through slot and is located on the folding piece.

In one embodiment of this disclosure, the length of the upper pull tab is greater than that of the lower pull tab, and the upper pull tab is folded back at an end away from the folding piece and overlaps the lower pull tab to configure another closed end.

In one embodiment of this disclosure, the upper pull tab comprises a breaking line located on an end away from the folding piece.

In one embodiment of this disclosure, an opening slot is defined in a middle position of the upper pull tab, the lower pull tab, and the folding piece to make the two fixing sections spaced apart.

In comparison with the related art, the pull strap of the electrical connector includes two fixing sections spaced apart and a holding section connected to the two fixing sections. The two fixing sections wrap around the locking piece, and the holding section protrudes out of the insulation seat. In this disclosure, the electrical connector is positioned relative to the mating connector through the latch portions of the locking piece engaging with the latch grooves of the mating connector. When the electrical connector is being detached from the mating connector, the force applied to the holding section of the pull strap may drive the two fixing sections and the locking piece to move, and the latch portions are moved to leave the latch groove to achieve an unlocked state, so that the electrical connector may be removed from the mating connector. Furthermore, the force applied to the pull strap of this disclosure is evenly distributed through the two fixing sections to drive two sides of the locking piece for balanced movement of both sides of the locking piece, which may avoid problems such as unlocking failure or damage to the pull strap due to uneven force direction or angle. Thus, the convenience of operation and practicality are achieved.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 depicts an inserting schematic view of the electrical connector and the mating connector according to this disclosure.

FIG. 2 depicts an exploded schematic view of the electrical connector according to this disclosure.

FIG. 3 depicts a cross-sectional view of the electrical connector according to this disclosure.

FIG. 4 depicts a schematic view of the separation of the electrical connector and the mating connector according to this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

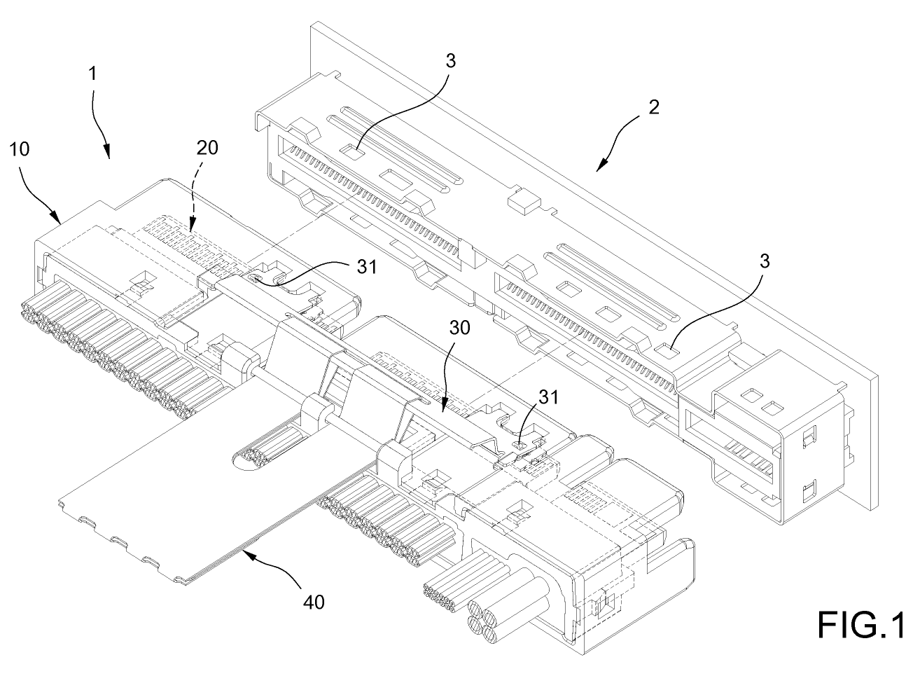

Please refer to FIG. 1, which depict an inserting schematic view of the electrical connector and the mating connector according to this disclosure. An electrical connector 1 with a pull-unlocking structure for inserting a mating connector 2 includes an insulation seat 10, a conduction part 20, a locking piece 30, and a pull strap 40. The conduction part 20 is disposed on the insulation seat 10 for electrical connection to transmit or receive signals or power from the mating connector 2. The locking piece 30 is combined with the insulation seat 10 for inserting the pull strap 40.

It is worth noticing that the electrical connector 1 includes a plurality of latch portions 31 located on the locking piece 30. Moreover, the mating connector 2 includes a plurality of latch grooves 3. When the electrical connector 1 is inserted into the mating connector 2, the electrical connector is positioned relative to the mating connector 2 through the engagement of the latch portions 31 with the latch grooves 3. A more detailed description of the electrical connector 1 with a pull strap unlocking structure is as follows.

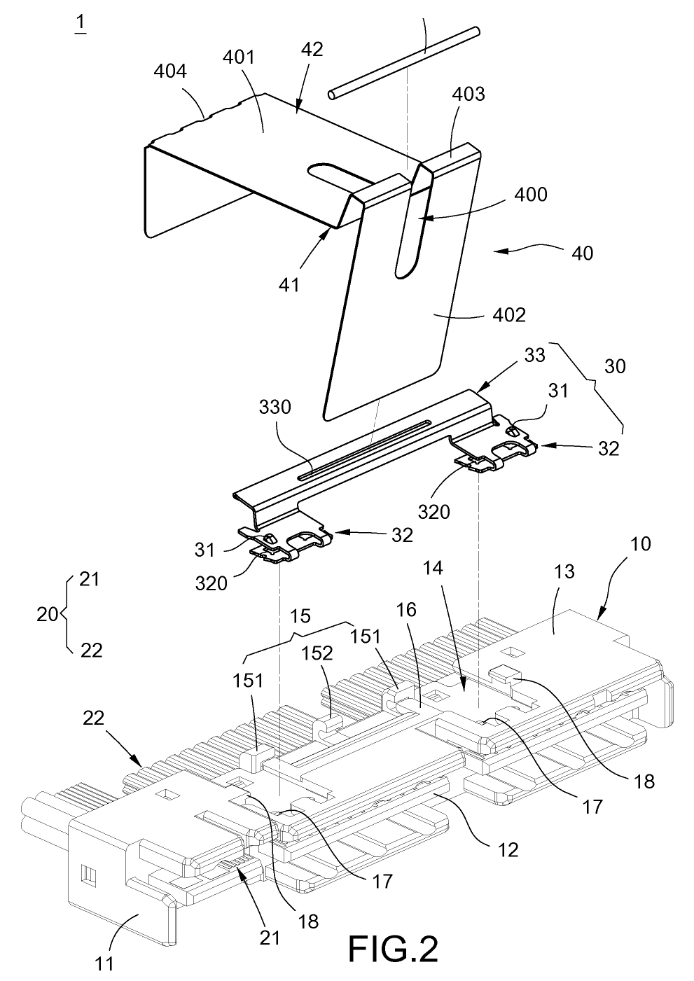

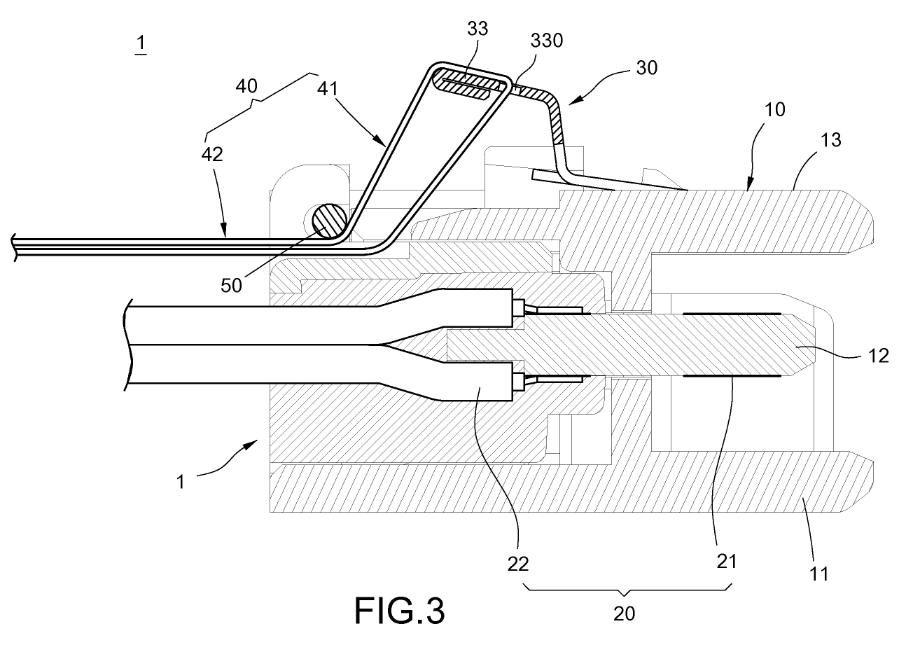

Please refer to FIGS. 2 and 3, which are an exploded schematic view of the electrical connector according to this disclosure and a cross-sectional view of the electrical connector according to this disclosure. The electrical connector 1 of this disclosure includes an insulation seat 10, a conduction part 20, a locking piece 30, and a pull strap 40. The insulation seat 10 includes a main body 11 and a tongue plate 12 connected to the main body 11. The main body 11 includes a top wall 13, and a receiving slot 14 is defined on the top wall 13. The conduction part 20 includes a plurality of conductive pads 21 arranged on the tongue plate 12 and a plurality of wires 22 connected to the conductive pads 21.

Moreover, the locking piece 30 includes two U-shaped spring plates 32 spaced apart and an insertion plate 33 connected to the two U-shaped spring plates 32. The two U-shaped spring plates 32 are positioned in the receiving slot 14. The insertion plate 33 straddles (extends between) the two U-shaped spring plates 32, and a through slot 330 is defined on the insertion plate 33. The pull strap 40 includes two fixing sections 41 spaced apart and a holding section 42 connected to the two fixing sections 41. Additionally, the two fixing sections 41 wrap around the through slot 330 of the locking piece 30 to be engaged with the locking piece 30 to make the holding section 42 protrude out of the insulation seat 10.

Moreover, the electrical connector 1 further includes a pressing shaft 50. The main body 11 includes a plurality of hooks 15 and a plurality of blocking blocks 16. Additionally, the pressing shaft 50 passes through the hooks 15 and is blocked by the blocking blocks 16 to press against the two fixing sections 41. In one embodiment of this disclosure, the hooks 15 include two outer hooks 151 located on the outsides of the two fixing sections 41 and a middle hook 152 located between the two fixing sections 41. Accordingly, the pressing shaft 50 may effectively and reliably press against the two fixing sections 41 spaced apart to apply force more evenly on the pull strap 40 and drive the locking piece 30 to move in a balanced manner.

Furthermore, the main body 11 includes a plurality of locking blocks 17 located in the receiving slot 14 and a limiting block 18 located on two sides of the receiving slot 14. Additionally, a plurality of locking slots 320 are defined on the bottoms of the two U-shaped spring plates 32. Through the locking slots 320 of the two U-shaped spring plates 32 engaging with the locking blocks 17 and the top walls of the two U-shaped spring plates 32 pressing against the limiting block 18, the locking piece 30 is positioned in the receiving slot 14 and combined with the insulation seat 10.

Specifically, the pull strap 40 includes an upper pull tab 401, a lower pull tab 402, and a folding piece 403 connected to the upper pull tab 401 and lower pull tab 402. Additionally, a closed end is configured on the pull strap 40 to wrap around the through slot 330 and is located on the folding piece 403. Furthermore, the length of the upper pull tab 401 is greater than that of the lower pull tab 402, and the upper pull tab 401 is folded back at the end away from the folding piece 403 and overlaps the lower pull tab 402 to configure another closed end.

In this embodiment, an opening slot 400 is defined in the middle position of the upper pull tab 401, the lower pull tab 402, and the folding piece 403 to make the two fixing sections 41 be spaced apart. Additionally, the upper pull tab 401 includes a breaking line 404 located on the end away from the folding piece 403. The breaking line 404 is disposed to facilitate the folding of the upper pull tab 401.

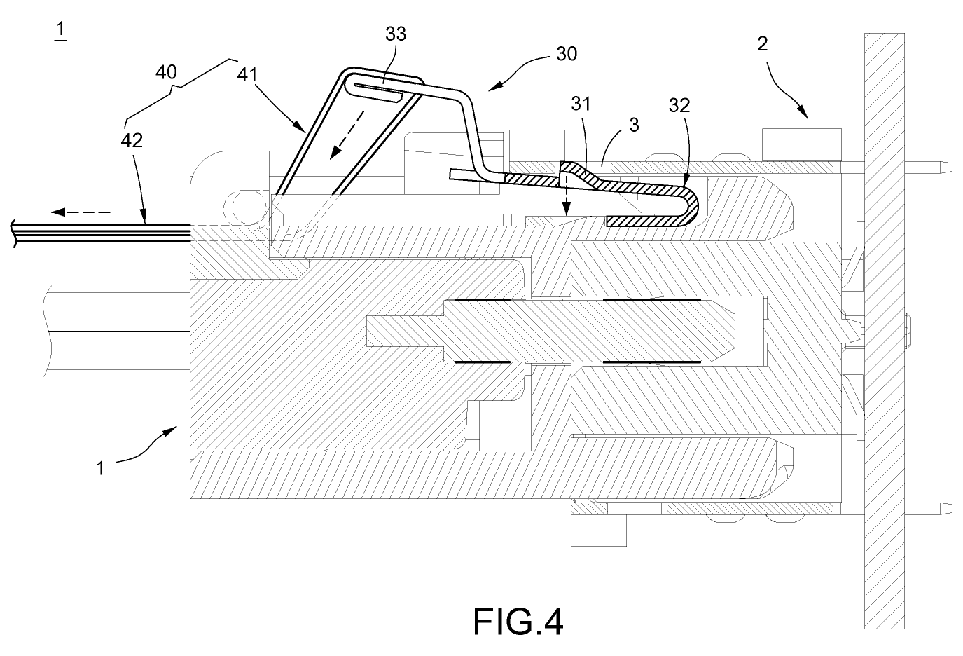

Please refer to FIG. 4, which depicts a schematic view of the separation of the electrical connector and the mating connector according to this disclosure. When the electrical connector 1 of this disclosure is being detached from the mating connector 2, the force applied to the holding section 42 of the pull strap 40 may drive the two fixing sections 41 and the inserting pieces 33 therethrough to move. At this time, the two U-shaped spring plates 32 may move along with the insertion plate 33 to drive the latch portions 31 to leave the latch groove 3. Accordingly, the electrical connector 1 and the mating connector 2 are released from the positioning state to achieve an unlocked state, so that the electrical connector 1 may be removed from the mating connector 2.

While this disclosure has been described by means of specific embodiments, numerous modifications and variations may be made thereto by those skilled in the art without departing from the scope and spirit of this disclosure set forth in the claims.

What is claimed is:

1. An electrical connector with a pull-unlocking structure for inserting a mating connector, the electrical connector comprising:
an insulation seat, comprising a main body and a tongue plate connected to the main body, the main body comprising a top wall, wherein a receiving slot is defined on the top wall;
a conduction part, comprising a plurality of conductive pads arranged on the tongue plate and a plurality of wires connected to the conductive pads;
a locking piece, comprising two U-shaped spring plates disposed spacedly and an insertion plate connected to the U-shaped spring plates, wherein the U-shaped spring plates are positioned in the receiving slot, the insertion plate straddles the two U-shaped spring plates, and a through slot is defined on the insertion plate; and
a pull strap, comprising two fixing sections disposed spacedly and a holding section connected to the fixing sections, wherein the fixing sections wrap around the through slot to be engaged with the locking piece to make the holding section protrude out of the insulation seat.

2. The electrical connector according to claim 1, wherein the main body comprises a plurality of locking blocks located in the receiving slot, and a plurality of locking slots are defined on bottoms of the U-shaped spring plates, and the locking blocks are engaged in the locking slots.

3. The electrical connector according to claim 2, wherein the main body comprises a limiting block located on two sides of the receiving slot, and top walls of the U-shaped springs are pressed under the limiting block.

4. The electrical connector according to claim 1, further comprising a pressing shaft, wherein the main body comprises a plurality of hooks and a plurality of blocking blocks located on a side of the receiving slot, and the pressing shaft passes through the plurality of hooks and is blocked by the blocking blocks to press against the fixing sections.

5. The electrical connector according to claim 4, wherein the hooks comprise two outer hooks located on outsides of the two fixing sections and one middle hook located between the two fixing sections.

6. The electrical connector according to claim 1, wherein the mating connector comprises a plurality of latch grooves, and the locking piece comprises a plurality of latch portions located on top walls of the U-shaped springs, and the electrical connector is positioned relative to the mating connector through the latch portions engaging with the latch grooves.

7. The electrical connector according to claim 1, wherein the pull strap comprises an upper pull tab, a lower pull tab, a folding piece connected to the upper pull tab and lower pull tab, and a closed end located on the folding piece and wrapping around the through slot.

8. The electrical connector according to claim 7, wherein a length of the upper pull tab is greater than that of the lower pull tab, and the upper pull tab is folded back at an end away from the folding piece and overlaps the lower pull tab to configure another closed end.

9. The electrical connector according to claim 7, wherein the upper pull tab comprises a breaking line located on an end away from the folding piece.

10. The electrical connector according to claim 7, wherein an opening slot is defined in a middle position among the upper pull tab, the lower pull tab, and the folding piece to make the two fixing sections be spaced apart.
